(19) United States
(12) Patent Application Publication
(10) Pub. No.: US 2020/0023658 A1
(43) Pub. Date: Jan. 23, 2020

(54) PRINTHEAD ADJUSTMENT DEVICES, SYSTEMS, AND METHODS

(71) Applicant: KATEEVA, INC., Newark, CA (US)

(72) Inventors: Alexander Sou-Kang KO, Santa Clara, CA (US); Christopher BUCHNER, Sunnyvale, CA (US)

(73) Assignee: KATEEVA, INC., Newark, CA (US)

(21) Appl. No.: 16/515,580

(22) Filed: Jul. 18, 2019

Related U.S. Application Data
(60) Provisional application No. 62/701,529, filed on Jul. 20, 2018.

(51) Int. Cl. B41J 25/308; B41J 2/045; B41J 2/21

(52) U.S. Cl. CPC B41J 25/3088; B41J 2/2132; B41J 2/04505

(57) ABSTRACT

A printing system includes a printhead carriage supporting a printhead and mounted to translate along a beam extending in an x-axis direction of an x-axis, y-axis, z-axis Cartesian coordinate system. A method of controlling the printing system includes sensing one or more of a rotational orientation of the printhead about the x-axis, y-axis, and the z-axis and a position of the printhead along the y-axis and z-axis. Based on the sensed one or more of the rotational orientation and the position, a position of one or more bearings arranged to support the printhead carriage on the beam is adjusted. Adjusting the position of the one or more bearings adjusts one or both of the rotational orientation of the printhead and the position of the printhead. Systems and methods relate to control of printing systems.

### CROSS-REFERENCE TO RELATED APPLICATIONS

This application claims priority to U.S. Provisional Application No. 62/701,529, filed Jul. 20, 2018, which is incorporated by reference herein in its entirety.

### TECHNICAL FIELD

The present disclosure relates to devices, systems, and methods for providing fine adjustment of printhead position and orientation, such as, for example, for use in industrial printing systems for manufacturing devices, such as displays.

### INTRODUCTION

The manufacture of various electronic devices using ink jet printing technology often benefits from a high degree of accuracy of ink droplet placement to achieve products that function properly and meet quality expectations. Examples of such devices include, but are not limited to, microchips, printed circuit boards, solar cells, electronic displays (such as liquid crystal displays, organic light emitting diode displays, and quantum dot electroluminescent displays), or other devices. In the example application in which ink jet printing is used to manufacture organic light-emitting diode (OLED) displays, organic materials (sometimes referred to as organic inks) are printed onto substrates to form pixels. Manufacture of such devices, and other devices such as the examples noted above, presents various challenges. For example, controlling the deposition of organic or other ink material, whether by inkjet printing, thermal printing, or other techniques, in desired locations in a precise, accurate, and reproducible manner so as to achieve a uniform deposition at the desired locations is difficult. There exists a need to improve upon existing systems and techniques to achieve these goals.

In the case of display devices, such as OLED displays, for example, with increases in resolution and corresponding decreases in pixel size, accuracy and precision of the print components, such as the printhead for example, becomes increasingly important to maintain quality of the resulting device. A need exists to provide various devices, systems, and methods that facilitate accurate and precise positioning and orientation of print components, such as the printhead position and orientation relative to the substrate on which material is to be deposited to provide accurate drop placement. Accurate drop placement can in turn contribute to higher possible resolution of the finished product and less material waste during manufacturing. It is further desired to provide such devices and methods in a configuration that promotes efficiency in manufacturing processes and reduces (e.g., minimizes) the overall complexity and weight of the associated printing equipment.

### SUMMARY

According to various exemplary embodiments of the present disclosure, a printing system includes a printhead carriage supporting a printhead and mounted to translate along a beam extending in an x-axis direction of an x-axis, y-axis, z-axis Cartesian coordinate system. A method of controlling the printing system includes sensing one or more of a rotational orientation of the printhead about the x-axis, y-axis, and the z-axis and a position of the printhead along the y-axis and z-axis. Based on the sensed one or more of the rotational orientation and the position, a position of one or more bearings arranged to support the printhead carriage on the beam is adjusted. Adjusting the position of the one or more bearings adjusts one or both of the rotational orientation of the printhead and the position of the printhead.

In yet other exemplary embodiments of the present disclosure, a method of controlling a printing system includes sensing information related to a position of the printhead along a path of travel extending in the x-axis direction, sensing information related to one or more of a rotational orientation of the printhead about the x-, y-, and z-axes and a position of the printhead along the y- and z-axes, adjusting one or both of the rotational orientation and position of the printhead by adjusting a position of one or more bearings of a printhead carriage carrying the printhead, and storing information correlating positions of the one or more bearings of the printhead carriage with corresponding positions of the printhead carriage along the path of travel.

In yet further exemplary embodiments of the present disclosure, a printing system includes a substrate support system configured to support a substrate having a surface to be printed. The substrate support system is configured to maintain the surface to be printed in an x-y plane substantially normal to a z-axis of an x-axis, y-axis, z-axis Cartesian coordinate system. The system includes a beam extending across the substrate support system in the x-axis direction, and a printhead carriage movably coupled to the beam to move in the x-axis direction, the printhead carriage comprising one or more bearings positioned to support the printhead carriage relative to the beam. at least one of the one or more bearings is coupled to an actuator selectively adjustable to adjust one or more of a rotational orientation of the printhead carriage about the x-axis, y-axis, and z-axis and a position of the printhead carriage in the y-axis direction and the z-axis direction.

Additional objects, features, and/or other advantages will be set forth in part in the description which follows, and in part will be obvious from the description, or may be learned by practice of the present disclosure and/or claims. At least some of these objects and advantages may be realized and attained by the elements and combinations particularly pointed out in the appended claims.

Both the foregoing general description and the following detailed description are exemplary and explanatory only and are not restrictive of the claims; rather the claims should be entitled to their full breadth of scope, including equivalents.

### SUMMARY OF THE DRAWINGS

FIG. 1 is a perspective view of a printing assembly for an industrial printing system according to an exemplary embodiment of the present disclosure.

FIG. 2 is a perspective view of a printhead carriage according to an exemplary embodiment of the present disclosure.

FIG. 3A is a schematic plan view of a printhead and carriage assembly according to an exemplary embodiment of the present disclosure.

FIG. 3B is a schematic plan view of the printhead and carriage assembly of FIG. 3A in an orientation rotated from the orientation shown in FIG. 3B.

FIG. 4 is a schematic side view of a gas bearing and actuator according to an exemplary embodiment of the present disclosure.

FIG. 5 is a schematic side view of a gas bearing and actuator according to another exemplary embodiment of the present disclosure.

FIG. 6 is a schematic side view of a gas bearing and actuator according to yet another exemplary embodiment of the present disclosure.

FIG. 7 is a block diagram of a control system for a printing system according to an exemplary embodiment of the present disclosure.

FIG. 8 is a flow chart showing a method of controlling a printing system according to an exemplary embodiment of the present disclosure.

FIG. 9 is a flow chart showing a method of calibrating a printing system according to another embodiment of the present disclosure.

FIG. 10 is a flow chart showing a method of controlling a printing system according to another embodiment of the present disclosure.

FIG. 11 is a schematic perspective view of a substrate and printhead according to an exemplary embodiment of the present disclosure.

FIG. 12 is a schematic, side view of a carriage and printhead relative to the beam (shown in cross-section) according to another exemplary embodiment of the disclosure.

FIG. 13 is a schematic, cross-sectional view of a carriage and printhead according to the exemplary embodiment of FIG. 12, with a cross section taken on a plane normal to the cross-sectional plane of FIG. 12.

FIG. 14 is a schematic, cross-sectional view of a carriage and printhead according to the exemplary embodiment of FIG. 12, shown in the same view as FIG. 13.

FIG. 15 is a schematic, cross-sectional view of a carriage and printhead according to the exemplary embodiment of FIG. 12, shown in the same view as FIG. 12.

### DETAILED DESCRIPTION

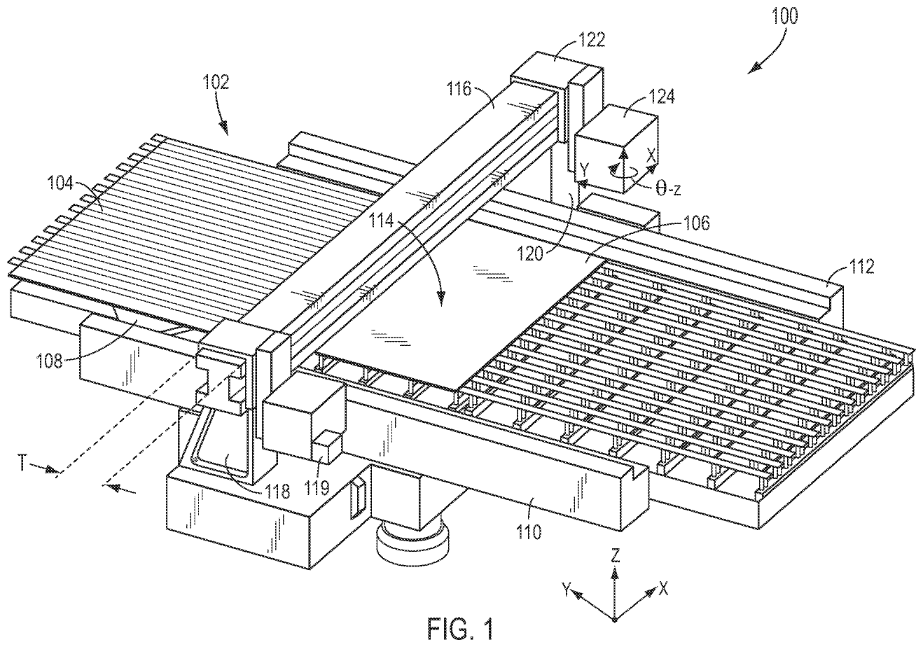

Various exemplary embodiments of the disclosure provide devices, systems, and methods for adjusting orientation of a printhead, for example to promote accuracy in one or both of the orientation (e.g., a rotation about an axis) and position (e.g., translation along an axis) of the printhead relative to a surface upon which the printhead is used to deposit material. For example, various exemplary embodiments of the present disclosure provide for fine adjustment of one or more of the three rotational orientations of the printhead about one or more of three cartesian axes, and one or more of the two translational positions about two of the cartesian axes. For brevity of description, some of the embodiments disclosed herein discuss adjustment of orientation about a single rotational axis. For example, the embodiments associated with FIGS. 1-3 disclosed herein discuss adjustment of a rotational orientation of the printhead about an axis extending normal to a print surface of a substrate, referred to herein as “θ-z” or equivalently “theta-z” adjustment. Other embodiments disclosed are configured to provide rotational orientation adjustments about any or all of the Cartesian (x, y, and z) axes, and translational position adjustment about any two of the three Cartesian axes normal to a direction of travel of the printhead defined along the third Cartesian axis.

Exemplary embodiments of the present disclosure provide significant advantages over other possible approaches to achieve printhead adjustment. For example, in one possible approach to providing orientation adjustment about a rotational axis, a printhead can be mounted on a rotational turntable that enables rotation (e.g., spinning) of the printhead about the axis normal to the print surface of a substrate. However, such mechanisms tend to be heavy and costly and, due to their size and weight, may be difficult to integrate with the overall printing system.

One alternative to mounting the printhead on a turntable or other rotational device is to provide a device or system for adjusting an orientation of the substrate so as to adjust the angular orientation of the print surface of the substrate relative to the axis normal to the print surface of the substrate. Such a mechanism to adjust the substrate orientation may, for example, be part of a substrate transport system that moves the substrate during printing. Such a system may be more complex than a substrate transport system that is not configured to make such theta-z adjustments to the orientation of the print surface of the substrate, and may introduce inaccuracies in other aspects of overall positioning of the substrate, such as for example, in the x- and or y-directions. Various exemplary embodiments of the present disclosure may reduce or eliminate the need for a substrate support system to be configured to rotate the substrate about the z-axis and include compensation movements along the x-axis. Further, embodiments of the present disclosure permit adjustment about more degrees of freedom and finer control over the adjustments, thereby providing better accuracy in ink placement and control.

Thus, embodiments of the present disclosure may be used with a substrate support system that is not required to rotate the substrate about the theta-z axis to correct for theta-z errors in printhead orientation, thereby reducing complexity and potentially increasing accuracy and precision of the substrate support system. However, those having ordinary skill in the art would appreciate that various exemplary embodiments of the present disclosure may nonetheless be used in conjunction with substrate support and/or substrate transport systems that are configured to rotate the substrate about the z-axis to provide combinations of ways to achieve relative theta-z adjustment of the printhead and the print surface of a substrate. For example, in one exemplary embodiment, the substrate transport system may be used to provide gross control of substrate orientation, while the adjustable printhead carriage may be used to provide fine control of the printhead orientation relative to the substrate.

The present disclosure contemplates various exemplary embodiments of a printhead and carriage assembly that can be rotated about one or more axes to change the rotational orientation of the printhead relative to other components of a printing system, including relative to a print surface. For example, the printhead can be rotated about an axis normal to a print surface of a substrate onto which the printhead deposits organic material to form pixels on the substrate, such that a relative theta-z adjustment of the printhead and print surface is achieved.

In some exemplary embodiments, the printhead carriage includes a plurality of bearings configured to support the printhead carriage and attached printhead on a beam (sometimes referred to as a gantry). The bearings comprise devices such as gas bearings, magnetic levitation (mag-lev) bearings, or other bearings or devices that reduce or minimize contact between the beam and the carriage while maintaining the carriage in a desired position and orientation relative to the beam. For example, the bearings may be configured to allow translational movement of the carriage along the beam in a single degree of freedom.

According to an exemplary embodiment of the disclosure, the position of one or more of the bearings can be changed relative to the carriage to change a rotational orientation of the carriage with respect to the beam, and accordingly with respect to one or more of the three cartesian axes. For example, one or more of the bearings can be moved along a longitudinal axis of the bearing (i.e., an axis oriented normal to a surface of the bearing(s) that face the beam) relative to the carriage to change the orientation of the carriage. In some embodiments, the bearings are carried on the carriage by ball-and-socket joints that passively rotate to enable the surface of the bearing that faces the beam to maintain a parallel relationship with the surface of the beam as the orientation of the carriage is changed.

In an exemplary embodiment, the one or more bearings that can be moved along their longitudinal axes are connected to the carriage by an actuator configured to move the bearing along each bearing's longitudinal axis. The actuator may be referred to herein as an actuation mechanism. In an exemplary embodiment, the actuator comprises a piezoelectric element that changes shape based on application of an electric current. In other exemplary embodiments, the actuator comprises devices such as, for example, a pneumatic actuator, a hydraulic actuator, or an electromechanical actuator such as a linear motor, a voice-coil type device, or another device. Optionally, the actuator includes a sensor such as a position encoder device that provides information (e.g., a signal) comprising information regarding the actual position of the actuator. Such information can be used by a controller in a feedback-type control system to verify the position of the carriage.

Referring now to FIG. 1, an exemplary embodiment of a printing system 100 that can be used for industrial printing applications is shown. The printing system is shown in isolation, however those of ordinary skill in the art would appreciate that the printing system may be located within an enclosure that has a controlled processing environment and that may be part of an overall industrial system for the manufacture of various electronic components, including displays (e.g., OLED displays). Non-limiting examples of such industrial systems for manufacture of electronic device components, including for printing of displays, are disclosed in U.S. Patent Application Publication Nos. US 2014/0311405 A1, US 2017/0028731 A1, and US 2018/0014411 A1, and U.S. Pat. No. 9,505,245, the entirety of each of which is incorporated by reference herein. The printing system 100 includes a substrate support system 102 for supporting a substrate 104. The substrate support system can comprise, for example, a chuck such as a vacuum chuck, or substrate floatation chuck having pressure ports, vacuum ports, or combinations thereof. In an exemplary embodiment, the substrate support system 102 comprises a substrate floatation chuck 106 and a motion system 108 configured to move the substrate 104 in a direction along the y-axis shown in FIG. 1 (those having ordinary skill in the art will appreciate that the x- and y-axes of the x-y-z cartesian system depicted could be switched with each other and thus should not limit the scope of the present disclosure, with the z-axis being chosen as normal to the print surface of the substrate). The motion system may include first and second beams 110, 112 oriented longitudinally along the y-axis, and devices such as grippers (not shown) may be configured to hold the substrate 104 and move the substrate along the y-axis within a printing region 114. Further details with respect to non-limiting examples of the configuration of a substrate support system that can be used as substrate support system 102 can be found in U.S. Patent App. Pub. Nos. US 2017/0028731 A1, US 2014/0311405 A1, and US 2018/0014411 A1, and U.S. Pat. No. 9,505,245, each of which is incorporated above.

The printing system 100 includes a beam 116 (e.g., a gantry or bridge) positioned over the substrate support system 102 in an area that can be defined as the printing region (the area underneath where a printhead spans while traversing the beam 116, as is explained further below). In the exemplary embodiment of FIG. 1, the beam 116 is mounted at one end to a first riser 118 and at an opposite end to a second riser 120 that support the beam 116 above the printing region. The beam 116 may comprise a stable material that can be dimensioned to a high degree of accuracy and exhibits rigidity and strength. In one non-limiting example, the beam 116 has a smooth (e.g., polished) surface. The beam 116 may comprise, for example and not limitation, materials such as ceramic materials, metals or alloys such as aluminum or steel, or composite materials. In the exemplary embodiment of FIG. 1, the beam 116 is made of granite.

The printing system 100 may include one or more printhead carriages 122 that are coupled to the beam 116 in a manner that permits the printhead carriages 122 to move in translation along the beam 116 in the x-axis direction shown in FIG. 1. The one or more printhead carriages 122 are configured to carry one or more printheads 124 that are used to deposit material onto the substrate 104. For example, the one or more printheads 124 may be inkjet printheads configured to deposit an ink (such as for example an organic OLED material) onto the substrate 104. The one or more carriages 122 move along the beam 116 to various positions along the x-axis to position the printheads 124 in the desired position for printing on the substrate 104 along the x-axis. Translational movement of the substrate 104 along the y-axis, combined with translational movement of the carriages 122 along the x-axis, permits the printheads 124 to access portions of the substrate 104 along the x-axis and y-axis to print organic material onto the desired areas of the substrate 104, for example, to achieve deposition of material in a pattern on the print surface. The carriages 122 and beam 116 may be configured such that a print face (not shown) of each of the printheads 124 is maintained in a parallel relationship with a print surface (surface facing toward the beam 116) of the substrate 104. In some exemplary embodiments, the printing system 100 is part of an overall industrial manufacturing system for manufacturing electronic devices, such as, for example substrates used in electronic displays, as described above.

The printing system 100 also may include one or more measurement devices associated with the printheads 124. For example, in the embodiment of FIG. 1, one or more sensors 119, such as, for example, interferometers, are coupled with each printhead 124 and are associated with an optical system (not shown) configured to measure the actual translational position and/or orientation of the printhead 124 and carriage 122 during a calibration procedure or during printing, as discussed in greater detail below. While only one sensor 119 is shown in FIG. 1, in some exemplary embodiments, the printing system 100 includes a plurality of measurement devices arranged to determine a rotational orientation of the one or more printheads 124 about one or more axes, such as about the x-axis, the y-axis, or the z-axis. In some exemplary embodiments, the printing system 100 includes three separate measurement devices (such as laser interferometers or other optical measurement devices) that measure the distance of three known points on the printhead from a plane defined by the surface of the substrate 104. From the three distance measurements, the rotational orientation of the printhead 124 can be determined about all three axes (e.g., x-axis, y-axis, and z-axis). Similarly, one or more additional measurement devices can be arranged to sense a position of the printhead along two axes normal to a direction of travel of the printhead 124. For example, in the embodiment of FIG. 1, the position of the printhead 124 relative to the beam 116 along the y-axis and the z-axis may be determined by additional measurement devices (such as optical sensors or other devices).

Additionally or alternatively, the printing system may be calibrated using a calibration device such as a “master glass” (not shown), a sheet of glass or other material having the same size as a substrate (such a substrate 104). The master glass comprises a pattern of marks having known positions on the master glass. One or more (e.g., two) high magnification cameras are used to determine the actual position of the marks relative to an expected position of the marks and thereby determine any errors occurring in the position and/or orientation of the printhead 124. Any such errors are recorded and used to correct the position and/or orientation of the printhead 124 using the systems and methods described herein.

Because of the high precision requirements of the printing system 100 (FIG. 1), small inaccuracies in various component parts of the printing system 100 may result in misalignment between one or more of the printheads 124 and the substrate 104 as the printhead carriages 122 move along the beam 116 during printing. For example, small variations in the surface of the beam 116 resulting from, e.g., manufacturing tolerances associated with production of the beam 116, may cause the rotational orientation of the carriage 122 about the z-axis shown in FIG. 1 to change as the carriage 122 moves across the beam 116. For example, variations in the thickness or flatness of the beam 116 potentially contribute to variations in the z-axis rotational orientation of the carriage 122 as the carriage moves along the beam 116. Although such changes in orientation may be minute (e.g., on the order of micro-radians), they nonetheless potentially compromise print accuracy (e.g., expected drop placement and/or trajectory) by changing the expected alignment of the printhead 124 with respect to the substrate 104. For example, the printhead surface from which the nozzles depositing ink extend and the print surface of the substrate may be oriented such that they are not aligned as desired in the theta-z aspect. This can cause both ink droplet placement inaccuracies and/or ink droplet deposition that may lead to uneven drying of the deposited droplets, and thus non-uniform film thicknesses in the final product.

In addition to variations in z-axis orientation of the carriage 122, variations in thickness or flatness of the beam 116 may result in other orientation and position variations as the carriage 122 moves along the beam 116. For example, an unsupported length of the beam 116 between the first and second risers 118 and 120, the beam 116 can potentially sag to some degree between the first and second risers 118 and 120. Such sagging of the beam 116 can result in rotational orientation changes of the carriage 122 about the y-axis as the carriage 122 is moved along the beam 116. Such rotational orientation disruptions about the y-axis can result in the printhead surface not being parallel to the print surface of the substrate. Likewise, such sagging may also result in the printhead surface being closer to the print surface of the substrate than intended or designed. Similarly, variations in beam thickness, flatness, and straightness can potentially cause other variations in the rotational orientation of the carriage 122 about the x-axis and y-axis, in addition to the z-axis variations discussed above. Likewise, the above-noted variations in the beam and/or other component supporting parts of the entire system can contribute to positional changes (translation) of the carriage 122 along the y- and z-axes. Exemplary embodiments of the disclosure can be configured to compensate (e.g., correct) for variations in the orientation of the carriage 122 and thus printhead 124 about the x-, y-, and z-axes, as well as position of the carriage 122 along two independent axes normal to a direction of movement of the carriage 122 (e.g., the y- and z-axes in FIG. 1).

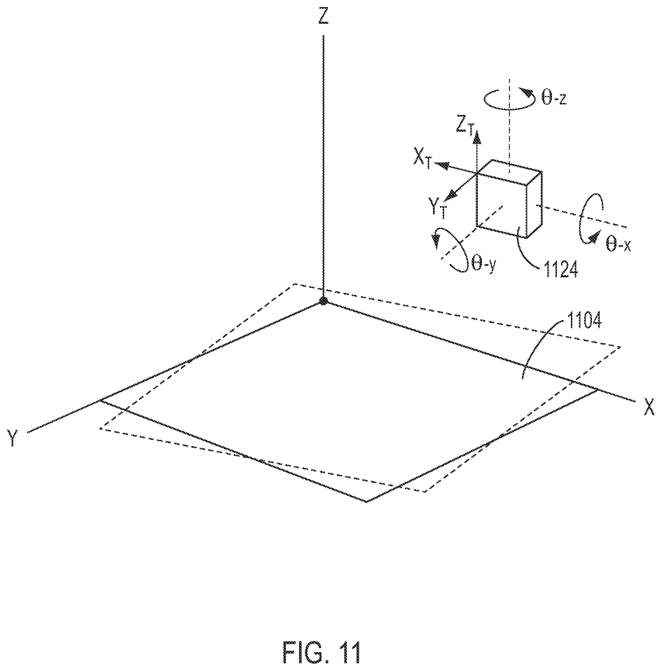

Referring now to FIG. 11, a schematic perspective view of a substrate 1104 is shown. FIG. 11 illustrates changes in orientation about the x, y, and z-axes (θ-x, θ-y, and θ-z, respectively), and translations along the x, y, and z-axes (x_{T}, y_{T}, and z_{T}, respectively). In exemplary embodiments of the disclosure, the translation x_{T} represents movement of the printhead 1124 along a path of travel, e.g., along the beam 116 (FIG. 1).

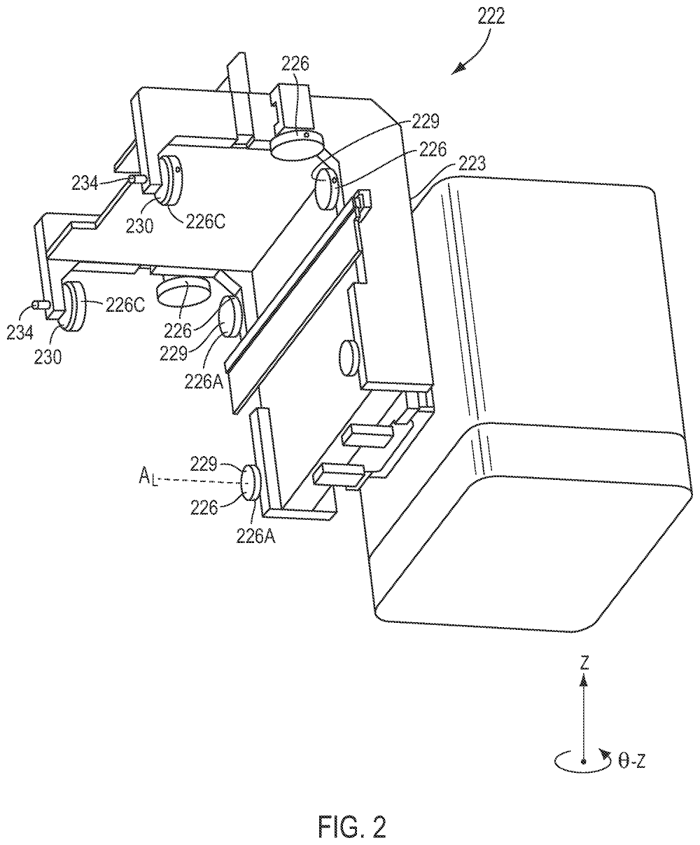

FIG. 11 also illustrates that potential misalignments in position or orientation of the substrate can contribute to misalignments between the printhead and substrate. In FIG. 11, the solid lines show the substrate 1104 in a first orientation. The dashed lines show the substrate 1104 in a second orientation in which the substrate 1104 is rotated relative to the first orientation about one of the x, y, or z-axes. The substrate 1104 may also be misaligned translationally with respect to the printhead 1124 in any of the x, y, or z-axes. Such rotations or translations of the substrate 1104 may contribute to misalignments between the substrate 1104 and a printhead 1124. Additionally, or alternatively, misalignments between the substrate 1104 and printhead 1124 may be the result of rotational misalignments of the printhead 1124 relative to the substrate 1124. A total misalignment between the printhead 1124 and the substrate 1104 may be a sum of a deviation of the substrate 1104 from an expected substrate orientation about the x, y, and z-axes and position in the x, y, and z-directions, and a deviation of the printhead 1124 from an expected printhead orientation about the x, y, and z-axes and position in the y and z directions (the x-direction being the direction of travel of the printhead 1124). Exemplary embodiments of the present disclosure, such as those shown and described in connection with FIGS. 2-10, enable adjustment of the carriage 122 (FIG. 1) and printhead 124 (FIG. 1) rotationally and translationally along various axes to compensate for such deviations from the expected alignment of the printhead 124 with respect to the substrate 104.

Referring now to FIG. 2, a printhead carriage 222 according to an exemplary embodiment of the disclosure is shown in greater detail. The printhead carriage 222 may include one or more devices configured to facilitate low-friction movement of the printhead carriage 222 along a beam, such as the beam 116 in FIG. 1, and accurate positioning of the carriage 222 with respect to the printing surface of a substrate. In exemplary embodiments, the printhead carriage 222 includes features configured to enable the carriage 222 to be supported and allow movement of the carriage 222 along the beam 116 while minimizing (e.g., reducing or eliminating) friction between the carriage 222 and the beam 116. The carriage 222 includes a printhead mounting portion 223 configured to accept a portion of a printhead (e.g., printhead 124 shown in FIG. 1) and to hold the printhead in place on the carriage 222 as the carriage 222 traverses the beam 116.

For example, in the embodiment of FIG. 2, the printhead carriage 222 includes a plurality of gas bearings 226. Each of the gas bearings 226 has a surface 229 that faces the beam (e.g., beam 116 shown in FIG. 1, and the gas bearings 226 are configured to accept a supply of pressurized gas (such as air or an inert gas) and to emit the gas to generate a layer of the air or other gas between the beam and the surfaces 229 (only 2 of which are visible in FIG. 2) of the gas bearings 226 to support the carriage 222 relative to the beam.

While the gas bearings 226 are discussed in further detail in connection with FIGS. 2-4, other exemplary embodiments may include other types of devices configured to reduce (e.g., eliminate) contact friction between a printhead carriage and the beam. For example, some exemplary embodiments may include various combinations of permanent magnets and/or electromagnets configured to utilize magnetic forces to levitate the carriage 222 with respect to the beam 116. Such devices are often referred to as “mag-lev” devices.

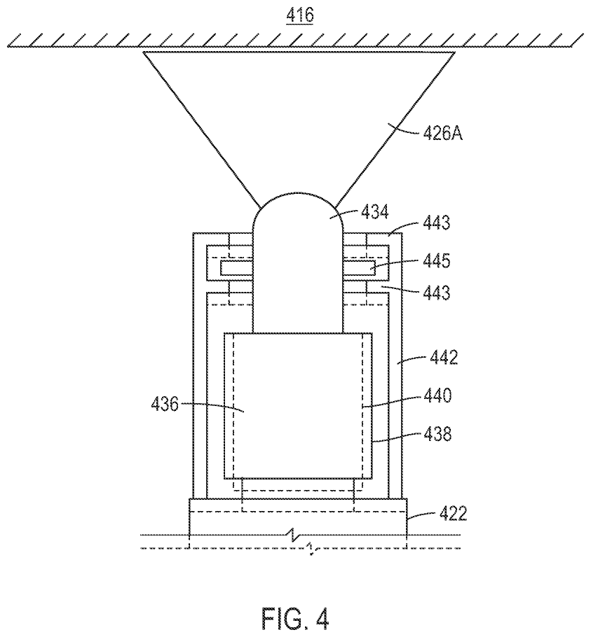

The gas bearings 226 may each be coupled to the carriage 222 in a manner that permits each gas bearing 226 to pivot relative to the carriage 222. Such pivoting ability may facilitate alignment of the surface 229 in parallel with a surface of the beam 116 that the surface 229 of the gas bearing 226 faces. Stated differently, the pivoting coupling enables surfaces 229 of the gas bearings 226 to be positioned flush against surfaces of the beam 116. Such positioning facilitates correct operating of the gas bearings 226, i.e., formation of a gas cushion between the gas bearings 226 and the beam 116. In an exemplary embodiment, as depicted in FIG. 4, a ball-and-socket joint 434 is used to couple the gas bearings 226 to the carriage 222. Thus, the ball-and-socket joints 231 facilitate “self-aligning” of the gas bearings 226 with respect to the beam 116. Each gas bearing 226 may “self-align” independently of the other gas bearings 226. While ball-and-socket joints 231 are shown in the embodiments described herein, other articulating assemblies, such as assemblies including one or more rotational bearings, are considered within the scope of the disclosure.

In exemplary embodiments of the disclosure, one or more of the gas bearings are coupled with the carriage 222 in a manner that permits movement of the one or more bearings along a longitudinal axis A_{L} of the bearing. As used herein, the “longitudinal axis” of a gas bearing refers to an axis perpendicular to a surface 229 of the gas bearing. For example, as shown in FIG. 2, adjusting gas bearings 226A are coupled to the carriage 222 in a manner that enables selectively moving the adjusting gas bearing 226A relative to the carriage 222 along the longitudinal axis A_{L} of the adjusting gas bearing 226A. In other words, the bearing surfaces 229 of the adjusting gas bearings 226A may be translated so that they protrude further away from or closer to the surface of the printhead carriage 222 upon which they are mounted. The gas bearings 226A may be referred to as “adjusting gas bearings 226A” or “translating gas bearings 226A.” Movement of the adjusting gas bearings 226A along the longitudinal axis of the bearings also results in the orientation of the carriage 222 being altered with respect to the beam 116.

While the exemplary embodiment of FIG. 2 depicts two adjusting gas bearings 226A located at upper and lower positions of one side of the carriage 222, other exemplary embodiments may have a single adjusting gas bearing, or more than two adjusting gas bearings 226A. For example, an exemplary embodiment includes four adjusting gas bearings in the four positions on the printhead carriage adjacent to the printhead mounting portion 223. Additionally, or alternatively, the carriage 222 may include more gas bearings located at positions other than the ones shown in FIG. 2, such as, for example and not limitation, six, eight, or more gas bearing positions adjacent the printhead mounting portion 223, of which one or more positions may be equipped with an adjusting gas bearing 226A.

The gas bearings 226C mounted on the carriage 222 opposite the adjusting gas bearings 226A are configured to passively move in a longitudinal direction to compensate for the longitudinal movement of the adjusting gas bearings 226A. That is, because the thickness T (FIG. 1) of the beam 116 is nominally constant, a change in longitudinal position of the adjusting gas bearings 226A requires the gas bearings 226C opposite the adjusting gas bearings 226A to move longitudinally so that the distance between the gas bearings 226C and adjusting gas bearings 226A remains constant and the clearances between the gas bearings 226A, 226C, and the beam 116 allow for gas to flow from the bearings for the proper functioning of the gas bearings 226.

In the exemplary embodiment of FIG. 2, gas bearings 226C, which may be referred to as compensating gas bearings, are coupled to the carriage 222 with spring posts 234 that allow for longitudinal movement of the compensating gas bearings 226C to compensate for longitudinal movement of the adjusting gas bearings 226A. The spring posts 234 may be configured with coil springs, Bellville springs, leaf springs, or other mechanical springs constructed from elastic materials such as metal alloys, polymers, or other materials, or may comprise gas springs such as variable volume pneumatic reservoirs, or other types of spring members.

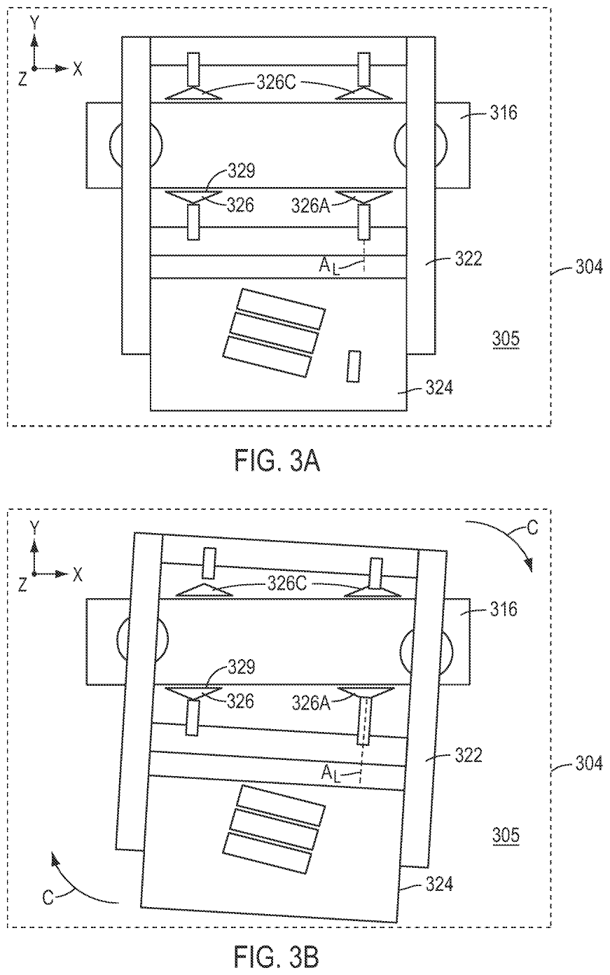

Exemplary embodiments with theta-z adjustment only will be described to explain various principles of operation, and then other orientation/positional adjustments will be described based on the same general principles. In use, to compensate for variations in orientation of the carriages 122 and the resulting orientations of the associated printheads 124 with respect to the substrate 104 (FIG. 1), the adjusting gas bearings 226A may be moved along their longitudinal axes to change the orientation of the carriage 122, for example, to return the orientation of the carriage 122 to an expected theta-z orientation relative to the print surface of a substrate, as discussed further in connection with FIGS. 3A and 3B.

Referring now to FIGS. 3A and 3B, schematic plan views of a printhead carriage 322 and a portion of a beam 316 of a printing system (such as printing system 100 shown in FIG. 1) are shown. The views in FIGS. 3A and 3B are looking down in a direction normal to and toward a print surface of the substrate, such as a print surface 305 of substrate 304 shown in dashed lines. In the configuration shown in FIG. 3A, adjusting gas bearings 326A are in a neutral position relative to the carriage 322, and a printhead 324 is in a neutral orientation relative to the substrate 304.

FIG. 3B shows a schematic plan view similar to that shown in FIG. 3A, with the adjusting gas bearings 326A extended along longitudinal axis A_{L} relative to the carriage 322 (only one of which is shown in the view of FIGS. 3A and 3B as the other is positioned underneath the visible one). Extension of the adjusting gas bearings 326A results in a rotational change in orientation of the carriage about the z-axis (the axis extending into and out of the plane of the drawing sheet of FIGS. 3A and 3B) in the clockwise direction as shown by the arrows C in FIG. 3B. Because changing the orientation of the carriage 322 about the z-axis potentially changes the y-axis position (i.e., the position in the vertical direction of FIGS. 3A and 3B), of the printhead 324 relative to the substrate 304, the control system of the print system 100 (FIG. 1) may be further configured to adjust the y-axis position of the substrate 304 to compensate for relative y-axis position changes between the printhead 324 and the substrate 304. Similarly, z-axis orientation changes to the carriage 322 may result in position changes of the carriage 322 along the x-axis (that is, position changes along the direction of the beam 316) which may be compensated for by movements of the carriage 322 along the beam 316.

While the exemplary embodiments of FIGS. 2-3B include two adjusting gas bearings (e.g., 226A in FIG. 2, one of which (326A) is illustrated in FIG. 3B), other embodiments can optionally have only one adjusting gas bearing or more than two adjusting gas bearings. For example, in some exemplary embodiments, the bearings diagonally opposite the adjusting gas bearings (i.e., the bearings at the top left of the drawing of FIGS. 3A and 3B) extend in a manner similar to the adjusting gas bearings. As an additional, non-limiting example, the gas bearings 326 and 326C in FIGS. 3A and 3B may be configured to selectively extend away from and retract toward the carriage 322 to actively compensate for the extension of the adjusting gas bearings 326A, rather than employing the compensating bearings 326C as shown in FIGS. 3A and 3B.

As the adjusting gas bearings 326A and compensating bearings 330 move relative to the carriage to change orientation of the carriage 322 relative to the beam 316, the rotational orientation of the carriage 322 about the z-axis changes, as shown in FIG. 3B. The ball-and-socket joints of the gas bearings 326, the adjusting gas bearings 326A, and the compensating bearings 326A adjust so that the surfaces 329 of the gas bearings 326, 326A, and 326C remain parallel with the surface of the beam 316, enabling the gas bearings 326, 326A and 326C to maintain the low friction (e.g., low or no friction) interface between the beam 316 and the carriage 322 in the orientation shown in FIG. 3B. In other words, the ball-and-socket joints passively adjust to ensure the surfaces 329 of the gas bearings 326, 326A and 326C remain flush against surface of the beam 316 to facilitate development of a gas cushion (e.g., gas layer) between the surfaces 329 of the gas bearings 326, 326A and 326C and surfaces of the beam 316.

In the exemplary embodiment of FIG. 4, adjusting gas bearings 426A are coupled to the printhead carriage 422 by a piezoelectric actuator 436 (FIG. 4). The piezoelectric actuator 436 is configured to change shape based on application of electrical current. In the exemplary embodiment of FIG. 4, the piezoelectric actuator 436 extends the adjusting gas bearing 426A away from the surface of the carriage 422 to which it is connected upon application of an electrical current to the piezoelectric actuator 436. For example, upon application of an electrical current, the piezoelectric actuator 436 may change from a first, unextended (e.g., retracted) state 438 shown by solid lines to a second, extended state shown by dotted lines 440. Application of electrical current may be controlled by a control system that controls, for example, the movements of the carriage 422 along a beam (e.g., beam 116, 216, or 316 shown in FIGS. 1-3B along the x-axis, and movements of the substrate (such as substrate 104 shown in FIG. 1 or 304 shown in FIGS. 3A and 3B) along the y-axis.

Piezoelectric components can provide desirable characteristics for the actuators 436, including but not limited to, for example, high compressive force, high accuracy, and relatively small movement. High compressive force may be required to be applied by the actuators 436 to overcome the force exerted on the beam (e.g., beam 116, 216, or 316 shown in FIGS. 1-3B by the gas bearings, which may be on the order of thousands of Newtons (N). For example, the force exerted on the beam by the gas bearings may be in a range of from about 500 N (113-pound force) to about 1500 N (337-pound force). Depending on the number of gas bearings, the area of the bearing surfaces, the weight of the printhead and carriage assembly, and other factors, the force exerted on the beam by the gas bearings may vary above or below the exemplary range provided above, for example, a force less than 500 N, or a force greater than 1500 N.

The desired range of rotation about the z-axis (or the x- or y-axis as applicable) of a printhead carriage may be less than one radian, and may be expressed in micro-radians. In an exemplary embodiment, the required range of rotation about the chosen axis of the printhead carriage to correct misalignments may be from 0 micro-radians to 50 micro-radians, or from 0 micro-radians to 100 micro-radians, or other ranges. In order to facilitate rotation through these ranges, actuators (such as actuators 436 shown in FIG. 4) may be required to translate the adjusting gas bearings a distance in the range of microns, for example, in a range of from about 0 microns to about 100 microns, depending on the pitch of (i.e., distance between) the adjusting gas bearings, and the desired change in rotational orientation of the printhead carriage about the chosen axis.

For example, the pitch of the adjusting gas bearings may be about 0.5 meters (19.7 inches), the adjusting gas bearings may have a range of travel of about 25 microns, and this range of travel of the adjusting gas bearings may enable a maximum rotation of the carriage about the chosen axis of about 50 micro-radians. In other exemplary embodiments, the range of orientation changes required to correctly orient the printhead carriage about the chosen axis and relative to the print surface of the substrate may be less than 50 micro-radians or more than 50 micro-radians, and the range of longitudinal travel of the adjusting gas bearings along their longitudinal axis may differ accordingly.

Actuators other than piezoelectric actuators are considered to be within the scope of the present disclosure. For example, in some exemplary embodiments, the adjusting gas bearing may be actuated by hydraulic devices, pneumatic devices, electro-mechanical devices such as linear motors, stepper motors connected to kinematic linkages, or any other device configured to move the bearings in the longitudinal direction based on an electrical or other control signal. As a further non-limiting exemplary embodiment, one or more of the actuators may comprise a voice-coil type device including a magnet and a moving electromagnet comprising a coil of wire, e.g., wound around a bobbin. Application of an electrical current to the coil generates a magnetic field that interacts with a magnetic field of the magnet, causing the bobbin to move. Further discussion of such devices is contained in U.S. Patent App. Pub. No. US 2018/0014411 A1, incorporated by reference above.

In the exemplary embodiment of FIG. 4, the carriage 422 and the adjusting gas bearing 426A may include a mechanical (i.e., “hard”) stop 442 to limit movement of the adjusting gas bearing 426A relative to the carriage 422 to ensure an associated printing system (e.g., printing system 100 shown in FIG. 1) maintains correct functionality when the adjusting gas bearings 426A are adjusted to the maximum extended position. In the embodiment of FIG. 4, the adjusting gas bearing 426A is shown adjacent to beam 416. While the mechanical stop 442 is illustrated and described specifically in connection with FIG. 4, the mechanical stop 442 can be included in any of the exemplary embodiments described herein.

In the exemplary embodiment of FIG. 4, the mechanical stop 442 comprises one or more annular members 443 positioned on either side of a shoulder 445 located on the actuator. The annular members 443 contact the shoulder 445 to prevent overextension or under-extension of the adjusting gas bearing 426A beyond a range of adjustability defined by the shoulder 445 and the annular members 443. The range of adjustability may be chosen based on the amount of extension required to correct the orientation of the carriage. For example, as noted above, in an exemplary embodiment, the adjusting bearings may have an adjustment range of about 25 microns. Other exemplary embodiments may have a greater range of adjustment, such as 50 microns, 100 microns, or more, or may have a lesser range of adjustment, such as 10 microns, 5 microns, or less. The mechanical stop 442 confines the range of motion of the actuator to a range in which the actuator provides stable, predictable movement for a given electrical input. For example, the range of motion of the actuator may be confined to a range in which the relationship between applied current and movement of the actuator is substantially linear. Additionally, the mechanical stop 442 can maintain the position of the actuator and carriage to a defined range when the actuator is not powered, such as when the printing system is powered off for maintenance or periods of non-use.

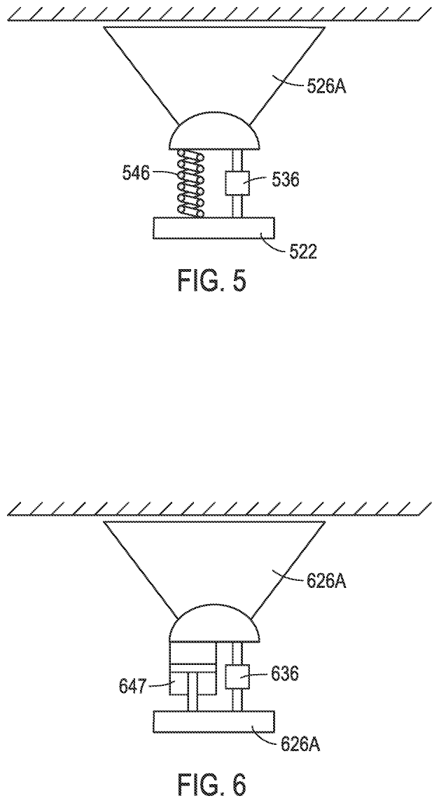

In yet other exemplary embodiments, the actuators may comprise one or more piezoelectric actuators coupled between the adjusting gas bearings in parallel with other devices configured to support at least a portion of the load applied between the adjusting gas bearings and the carriage. Such devices may include, for example, elastically-biased members such as mechanical or pneumatic springs. For example, referring now to FIG. 5, a schematic side view of an adjusting gas bearing 526A and carriage 522 is shown. Coupled between the adjusting gas bearing 526A and the carriage 522 is a spring 546 (such as a coil spring) mounted in parallel with an actuator (such as a piezoelectric actuator) 536. The spring 546 can support a portion of the load applied between the adjusting gas bearing 526A and the carriage 522, while the piezoelectric actuator 536 enables fine positioning of the carriage 522 relative to the adjusting gas bearing 526A in the manner discussed above. For example, the load may be an applied force resulting from the weight of a printhead (not shown in FIG. 5) supported by the carriage 522 and at least a portion of the weight of the carriage 522.

Referring now to FIG. 6, a configuration similar to that described in connection with FIG. 5 is shown. In FIG. 6, in lieu of the coil spring 546, a pneumatic spring 647 (comprising, for example, a piston-cylinder device) is positioned between an adjusting gas bearing 626A and carriage 622 in parallel with a piezoelectric actuator 636. The pneumatic spring 647 supports a portion of the load applied between the adjusting gas bearing 626A and the carriage 622, while the piezoelectric actuator 636 enables fine positioning of the carriage 622 relative to the adjusting gas bearing 626A.

During use, the printhead carriage (such as printhead carriage 122, 222, 322, or 422) may be moved along a beam (such as beam 116, 316, or 416, shown in FIGS. 1-3B) by a linear motor system including a stator (not shown) connected to the carriage 422 and a series of permanent magnets or electromagnets (not shown) embedded in or otherwise affixed to the beam. Extending the adjusting gas bearings 426A beyond a certain extent could potentially impact alignment of the stator with respect to the magnets, and could cause the stator to impact the magnets or the beam. The mechanical stop 442 may prevent extension of the adjusting gas bearings 426A beyond a particular distance at which the linear motor retains proper functionality and the carriage 422 does not impact the beam. While the mechanical stop is shown specifically in the embodiment of FIG. 4, the mechanical stop may be used with any of the other embodiments shown in the present disclosure, or combinations of embodiments.

In some exemplary embodiments, the printing system may incorporate a system for correcting for deviation from an expected transport path of a substrate conveyance system, such as substrate support system 102 (FIG. 1). Such a correction system may be as substantially described in U.S. Patent App. No. U.S. Patent App. Pub. No. US 2018/0014411 A1, or U.S. Pat. No. 9,505,245, issued Nov. 29, 2016, the entire contents of each of which are incorporated herein by reference. Such a system may include a conveyance system, such as a substrate gripper, configured to guide a component, such as a substrate for example, along a transport path to assist with manufacturing. In a typical implementation, the transport path can be on the order of meters, while the required positioning can be micron-scale or even finer (e.g., nanometer scale or finer). To assist with precise positioning, one or more sensors are used to detect deviation between the component (e.g., substrate) and an optical beam, in one or more dimensions. Deviation detected by the one or more sensors is then used to derive position correction signals that are fed to one or more transducers and used to offset the deviation. This allows the component to track the optical path notwithstanding fine mechanical error associated with the transport path. In an exemplary embodiment, the one or more sensors provide feedback that causes the transducers to always “zero-out” positional and/or rotational error.

In exemplary embodiments of the present disclosure, one or more aspects of the path-corrected conveyance system may be used in conjunction with the adjustable printhead carriage (such as printhead carriage 122, 222, 322, 422, 522, 622, or 1222). The combination of the printhead carriage configured to provide rotational adjustment about various axes of rotation and positional adjustment along the various axes and the path correction provided by embodiments of the disclosures of U.S. Patent App. Pub. No. US 2018/0014411 A1 or U.S. Pat. No. 9,505,245 may provide high accuracy of printhead and substrate positioning to ensure precise, accurate, and repeatable print results. Further, the provision of rotational and positional adjustment of the printhead carriage may reduce or eliminate the need for rotational adjustment of the substrate by the conveyance system, thereby permitting a conveyance system having fewer components for achieving adjustability, and less associated complexity, to provide complete adjustment of the substrate and printhead as needed to correct both for transport path error (deviation from expected transport path) and rotational error or positional error (e.g., theta-z error or other deviations from expected rotational alignment or position of the printhead) to provide accurate print results.

Embodiments of the present disclosure may include a control system configured to rotate or translate the carriage (e.g., carriage 122, 222, 322, 422, 522, 622, or 1222) as necessary to correct for rotational or positional inaccuracies resulting from deviations in straightness and/or flatness in the beam 116 or components associated with the substrate support system 102. Such a control system may include one or more sensors configured to determine the actual position and orientation of the carriage and the substrate conveyance system and one or more processors operably coupled to the one or more sensors. In exemplary embodiments of the present disclosure, the one or more sensors may comprise one or more components such as encoders, interferometers (e.g., laser interferometers), other optical measurement devices such as cameras, or other devices. The control system may be an integrated control system that controls both the printhead carriage and the conveyance system, or may comprise two substantially discrete control systems that independently control each of the substrate conveyance system and the printhead carriage.

In exemplary embodiments, the desired position or rotational orientation of a printhead carriage relative to a particular rotational axis, or the desired amount in which the position and/or orientation of the carriage must be adjusted to compensate for misalignment is determined based on information about the actual position and orientation of the printhead carriage as it translates in the x-axis direction(s) along the beam. In an exemplary embodiment, as the printhead carriage is moved along the beam, measurement devices on the printhead (e.g., printhead 124, 324 shown in FIGS. 1, 3A, and 3B) are used to determine any orientation misalignments or positional inaccuracies that occur as the printhead carriage moves along the beam. For example, one or more of cameras, interferometers such as laser interferometers, or other measurement devices as noted above may be used to collect information regarding the orientation and position of the printhead as the carriage moves along the beam. Data regarding the orientation and position may be provided to a control system that controls the position of the printhead carriage (printhead carriage 122, 222, 322, 422, 522, 622, or 1222), the y-position of a substrate (such as substrate 104, 304 shown in FIGS. 1, 3A, and 3B) and the rotational orientation of the printhead carriage (and thus the rotational orientation of the printhead(s) carried by the printhead carriage) about the one or more rotational axes (e.g., the theta-z orientation of the printhead carriage). The control system may also perform other control functions, such as loading and unloading the substrate, controlling deposition of organic material through the printhead, and other functions of the printing system 100.

In addition, the center of rotation of the printhead about any of the x-, y-, or z-axes may be offset from the center of the printhead, and therefore, adjusting the rotational orientation of the carriage about an axis may also result in movement of the printhead in x-, y-, or z-directions. The control system may be programmed or otherwise configured to compensate for these movements, and move the carriage or the substrate an appropriate amount based on rotational adjustment about the x-, y-, and/or z-axis.

In some exemplary embodiments, the control system may operate on a “real-time” basis, in which data regarding the actual position and/or orientation of the substrate carried by the conveyance system or the printhead carriage is collected and processed as the carriage moves along the beam 116, 316, 416, 1216. The control system may then process the real-time data and adjust the position and/or orientation of the conveyance system or printhead carriage to account for inaccuracies in the orientation or position of the conveyance system or carriage during a printing operation.

As an alternative to the “real-time” control configuration, in various exemplary embodiments, the control system may record the carriage movements required to compensate for any inaccuracies present in the beam along which the carriage moves during an initial calibration procedure. The required corrections to orientation of the carriage can be calculated based on measurements taken by one or more sensors, such as interferometers or other measurement devices, as the carriage traverses the beam. The measurements may be collected into a table or map correction values associated with positions of the carriage along the beam. Each correction value is thereby associated with a specific location of the carriage, and the collection of correction values accounts for the specific inaccuracies present in the beam, such as variations in flatness or thickness of the beam. The table or map of correction values is thus associated with the specific beam used in the printing system on which the calibration was carried out. The correction values may be stored on electronic memory operable coupled with the processor of the control system, and the control system applies the correction values associated with each position of the carriage on the beam or conveyance system along the transport path, without a need to re-measure the position and/or orientation inaccuracies of the carriage and conveyance system each time the carriage traverses the beam and the conveyance system moves along the transport path.

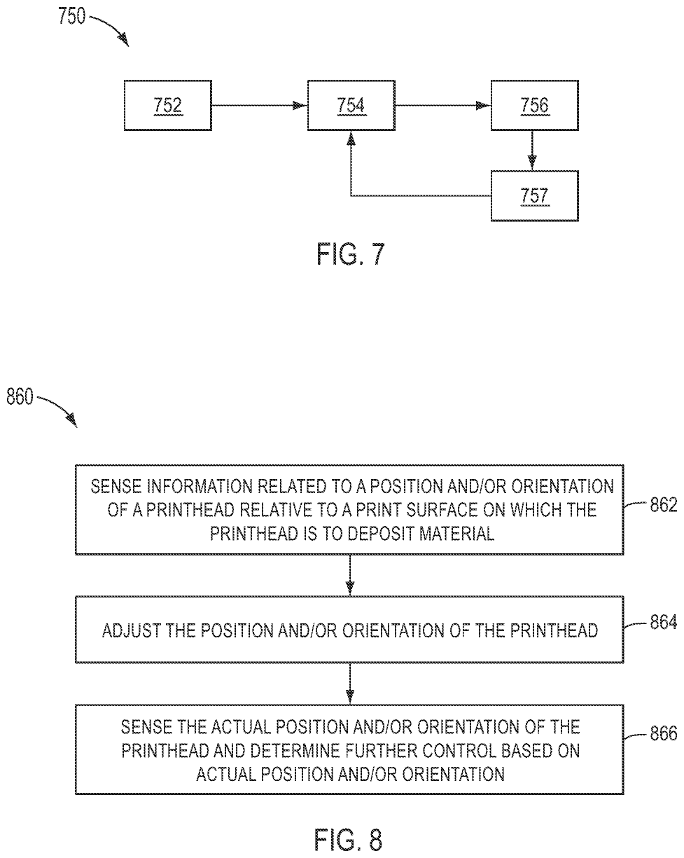

Referring now to FIG. 7, a block diagram illustrating a control system 750 for controlling a printing system according to an exemplary embodiment of the present disclosure is shown. The control system 750 includes at least one sensor device 752 configured to generate an output signal representative of an orientation and/or position of a printhead (such as printhead 124, 324, 1224 in FIGS. 1, 3A, 3B, and 12-15) relative to a print surface of a substrate on which the printhead is configured to deposit material, such as ink. The sensor device 752 may include one or more sensors such as interferometers, encoders, or other devices as discussed herein and/or as those with ordinary skill in the art would be familiar. In one embodiment, the sensor device 752 includes one or more laser interferometers.

The sensor device 752 is operably coupled to a controller 754, such as a computer system including, for example, a processor and electronic storage media. The controller 754 receives information from the sensor device 752 regarding the rotational orientation and/or position of the printhead relative to the print surface. In addition, in some embodiments, the controller 754 may receive information from other devices associated with the printing system, such as other sensors configured to generate information related to the rotational orientation and positions of the printhead in x, y, and z directions (such as along the x, y, and z axes discussed in connection with the exemplary embodiments associated with FIGS. 1-4 above). Additionally, or alternatively, the controller 754 may receive information from other devices and systems of the printing system, such as a system configured to support and/or transport a substrate (e.g., the substrate support system 102 shown in FIG. 1) and a system configured to move the printhead (e.g., the motion system 108 shown in FIG. 1). The controller 754 may receive inputs related to operational aspects of the printing system, such as position of the printhead, substrate, operational state of the printing system, information related to other components of the printing system such as a gas enclosure, or other inputs.

The controller 754 may be operatively coupled to various components of the printing system, such as a substrate support system (e.g., 102 in FIG. 1) and a motion control system (e.g., 108 in FIG. 1), or other components of a printing system. Based on inputs from the sensor device 752, and any other sensors or input devices operatively connected to the controller 754, the controller 754 may generate output signals to control the printing system. For example, the controller 754 may be configured to send the output signals to one or more control devices 756 of the printing system. The control devices 756 may include, for example, controllable components (such as motors, servomotors, linear motors, or other actuators) associated with components of the printing system.

In the exemplary embodiment of FIG. 5, the controller 754 sends an output signal to a control device 756 comprising, for example, one or more actuators (such as a piezoelectric actuator 436 shown in FIG. 4) configured to change position and/or shape based on an applied electrical current. In this manner, an output signal from the controller 754 may be used to control the actuation state of the actuators 436 and the corresponding orientation of the printhead (such as printhead 124, 324 in FIGS. 1 and 3A/3B). Further, in exemplary embodiments, the controller 754 may provide additional outputs that control the operational state of the printing system, such as by controlling a substrate support system, motion control system, or other operational aspects of the printing system.

In some exemplary embodiments, the control device 756 optionally includes a device configured to provide feedback to the controller 754. For example, in an exemplary embodiment, the control device 756 is a piezoelectric actuator with an associated encoder device 757 configured to provide feedback regarding the actual position of the control device 756 to the controller 754. The encoder device 757 may be an optical encoder, a magnetic encoder, or any other device configured to generate a signal based on position or movement of the control device 756. If, based on the feedback received, the control device 756 has reached a target position, the controller 754 maintains the control device in the target position. Once the feedback from the encoder device 757 indicates the control device 756 has reached a target position, the controller 754 ceases to move the control device 756.

Referring now to FIG. 8, a flow chart 860 shows a workflow for adjusting a position of a printhead carriage along an axis and/or an orientation of the printhead carriage about an axis. As used throughout, the term “position” refers to a translational location along an axis, and the term “orientation” refers to a rotational orientation about an axis. The exemplary embodiment of FIG. 8 represents one example of a control method that uses real-time input regarding the actual position and/or orientation of the carriage, and adjusts the position and/or orientation of the carriage based on the real-time input. At 862, the workflow includes sensing information related to a rotational orientation of a printhead about an axis normal to the print surface on which the printhead is to deposit material. The printhead may be carried by a printhead carriage movably mounted on a beam extending across a substrate support system. The sensed information related to the sensed orientation of the printhead can be provided to a controller, such as controller 754 (FIG. 7) in various exemplary embodiments.

At 864, one or both of the position along an axis and the rotational orientation of the printhead carriage about an axis is adjusted, e.g., based on the sensed information. As discussed above, in exemplary embodiments, such adjustment may be accomplished by one or more actuators, such as actuators 436 (FIG. 4), that change in size, shape, position, or other characteristic to adjust the orientation of the printhead relative to the substrate about the axis normal to the substrate print surface. For example, as discussed above in connection with FIGS. 1-4, one or more non-contact bearings such as gas bearings 226, 326, and 426 (FIGS. 2, 3A, 3B, and 4) may be moved by the actuators along respective longitudinal axes of the bearings to alter the orientation of the printhead. In various exemplary embodiments, such actuators may be controlled by a controller, such as controller 754 (FIG. 7). For example, a controller receiving sensed information may be used to output signals that control the actuators to adjust the printhead carriage.

At 866, one or both of an actual orientation about an axis and actual position along an axis of the printhead carriage is sensed and further control or adjustments may be made if needed based on the actual orientation and position, or the orientation and position can be verified and adjustment ceased. For example, in an exemplary embodiment, the controller receives a signal from one or both of an encoder (e.g., encoder device 758 in FIG. 7) or another measurement device, such as a sensor device 752 (FIG. 7). The encoder or other measurement device may sense one or both of actuator position, bearing position, or carriage position, and provide the sensed information to the controller as a signal indicative of the actual position of the sensed component. The controller evaluates the received signal to determine the actual orientation and position of the carriage based on, e.g., stored geometric relationships that correlate positions of various components, such as the actuator and/or bearing, with the actual orientation and/or position of the carriage. If the carriage is not in the desired orientation and/or position based on the information the controller receives, the controller can make further adjustments to the orientation and/or position of the carriage until the signal received from the encoder or sensor indicates the orientation and/or position is correct. As discussed in connection with FIGS. 3A and 3B above, for example, correction of theta-z orientation of the carriage may result in position changes of the printhead relative to the substrate in the x- and y-directions. The controller may be configured to adjust the x- and y-direction position of the printhead as needed based on the orientation changes of the printhead about the z-axis. Likewise, changes in rotational orientation about the x- or y-axes may result in translational positional changes along the x-, y-, and z-axes, and the controller may be programmed to correct such positional changes based on information from one or more or sensors.

As an alternative to the real-time control method as described above in connection with FIG. 8, in some exemplary embodiments, the control system may be programmed with information from an initial calibration procedure, and the information obtained during the initial calibration procedure is used by the controller to control the carriage orientation during subsequent printing operations. In one example of such an arrangement, the measurement devices used to determine the orientation of the carriage as it moves along the beam are only temporarily affixed to components of the printing system for the calibration, and can later be removed from the printing system once the calibration procedure is complete. Thus, such an arrangement may serve to reduce the cost and overall complexity of the printing system, as the measurement system is not required to be permanently installed on the printing system.

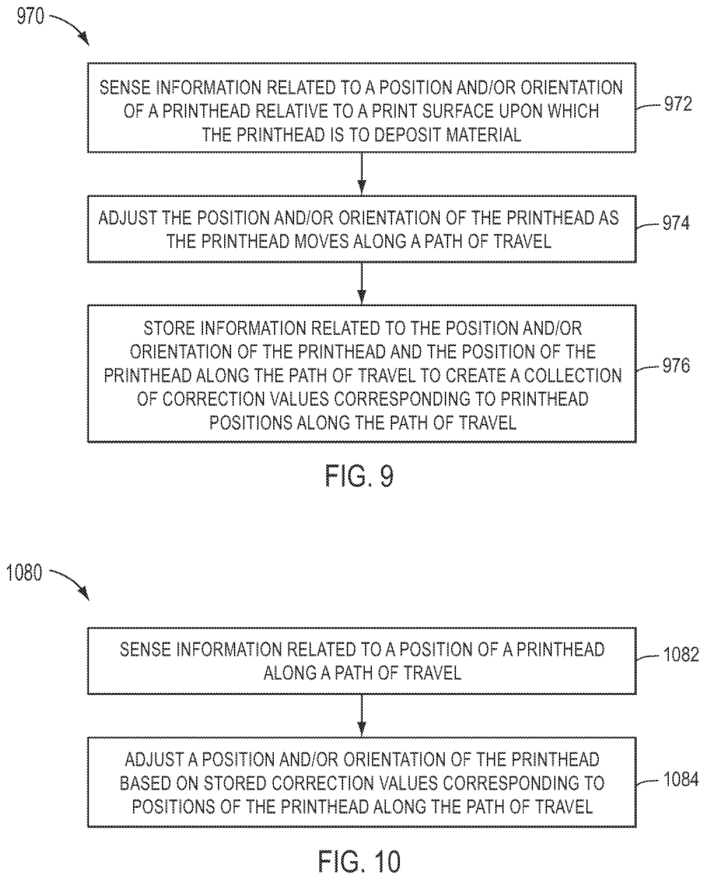

Referring now to FIG. 9, another exemplary embodiment of a work flow 970 includes an initial calibration procedure using one or more measurement devices, after which the one or more measurement components used in the initial calibration procedure are not required to be used for subsequent printing operations. For example, at 972, the work flow 970 includes sensing information related to one or both of a rotational orientation and a position of a printhead relative to a print surface upon which the printhead is to deposit material. Such sensing may be done by measurement devices such as interferometers, cameras, and other measurement devices as discussed above. In various exemplary embodiments, measurement information from the measurement devices related to the orientation and position of the printhead is received at a controller as the printhead carriage is moved along a path of travel, such as along the beam 116, 316, 416. At 974, the orientation and/or of the printhead is adjusted as the printhead moves along a path of travel. For example, in various exemplary embodiments, a controller sends a signal to one or more actuators to adjust the rotational orientation or the position of the carriage and printhead until the information from the measurement devices indicates the orientation and/or position of the printhead has reached a desired orientation. Optionally, a sensor such as an encoder coupled with the actuator provides a signal to the controller with information regarding the actual position (e.g., an amount of linear extension) of the actuators relative to the carriage. Another sensor may provide information to the controller regarding the position of the carriage and printhead along the path of travel, such as along the beam. Additional adjustments to position and/or orientation of the printhead may be made as necessary based on orientation or positional changes of the printhead resulting from the adjustments made by the one or more actuators.

At 976 the information relating to the rotational orientation of the printhead and the position of the printhead along the path of travel and directions normal to the path of travel is stored to create a collection of correction values corresponding to printhead positions along the path of travel. For example, in various exemplary embodiments, the controller associates the information regarding the position of the one or more actuators with the position of the carriage along the beam to generate a collection of values of actuator positions associated with locations of the carriage along the beam. This collection of information can optionally include values of x-, y-, and z-direction corrections for given carriage locations along the beam as required to compensate for changes in position resulting from rotation of the carriage about a given axis. The collection of associated values may be referred to as a table, a list, a map, etc., and may be stored on an electronic memory operably coupled with the processor. The electronic memory may include, without limitation, random access memory (RAM), read-only memory (ROM), electronic storage such as a disk drive, flash memory, or any other type of electronic storage media or device.

When the printing system is in use after the initial calibration procedure, the controller adjusts the orientation and/or position of the carriage and printhead based on the position of the carriage along the beam by controlling the one or more actuators on the carriage according to the actuator extension values associated with the position of the carriage as the carriage is moved across the beam. For example, referring now to FIG. 10, a workflow 1080 is shown. At 1082, information related to a position of a printhead along a path of travel is sensed. For example, in various exemplary embodiments, during a printing operation, the controller receives information regarding the position of the carriage along the beam. At 1084, a rotational orientation and/or a position of the printhead is adjusted based on stored correction values corresponding to positions of the printhead along the path of travel. For example, in various exemplary embodiments, the controller may adjust the orientation or position of the carriage based on values stored in the electronic memory, such as the data stored in connection with act 976 in the workflow of FIG. 9. In this way, the control system can correct orientation and positional errors based on an initial calibration and without reliance on real-time measurements, thus reducing the need for measurement sensors and systems to be integrated with the printing system and consequently reducing the complexity of the printing system.

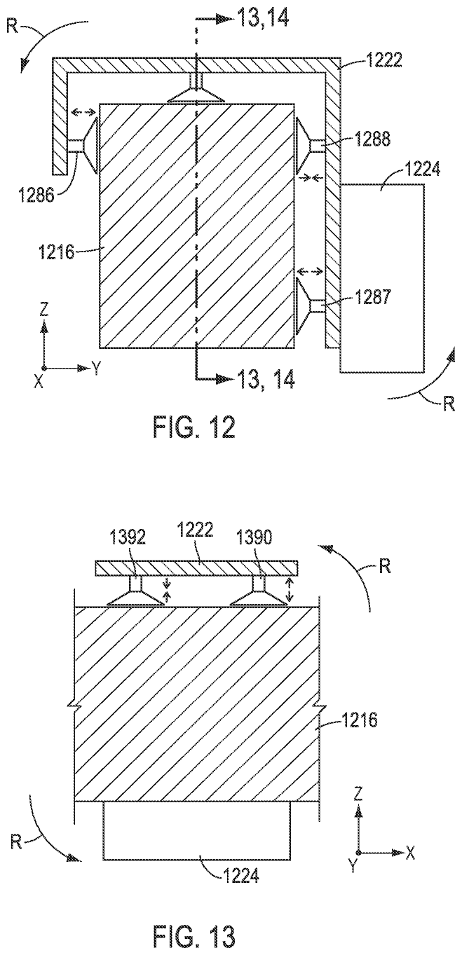

FIGS. 12-15 are schematic illustrations showing adjustments to the orientation of the carriage about the x- and y-axes (in the coordinate system of FIG. 1) using one or more actuators on the carriage. While in exemplary embodiments described above, only two of the gas bearings 226 are adjusting gas bearings and are configured to provide adjustment of orientation about the z-axis, in other exemplary embodiments, the system may include more than two adjusting gas bearings to facilitate adjustments of orientation about and/or position along additional axes. In some exemplary embodiments, each of the gas bearings may be attached to an actuator and thus may be an adjusting gas bearing. The number of gas bearings capable of being adjusted can be based on the number of discrete adjustments desired, with more gas bearings being provided with actuators as the number of adjustments rises.

Referring now to FIG. 12, a cross-sectional view of a beam 1216, carriage 1222, and printhead 1224 taken in a plane normal to a length of the beam 1216 is shown. In the drawing orientation of FIG. 12, the x-axis extends into and out of the plane of the drawing. To cause a rotation of the carriage 1222 about the x-axis, actuators associated with adjustable bearings 1286, 1287 are actuated to increase a distance between the carriage 1222 and a surface of each of the adjustable bearings 1286, 1287 facing the beam 1216. Actuators associated with adjustable bearings 1288 are actuated to decrease a distance between the carriage 1222 and a surface of the adjustable bearings 1288 facing the beam 1216. As a result, the carriage 1222 and associated printhead 1224 rotates about the x-axis as indicated by arrows R, counter-clockwise in the view of FIG. 12. If a clockwise rotation of the carriage 1222 and printhead 1224 about the x-axis is desired, actuators associated with the adjustable bearings 1286, 1287 are actuated to decrease the distance between the carriage 1222 and a surface of the adjustable bearings 1286, 1287 facing the beam 1216, and the adjustable bearings 1288 are actuated to increase the distance between the carriage 1222 and a surface of the adjustable bearings 1288 facing the beam 1216. In this manner, the adjustable bearings 1288 can be utilized to compensate for inaccuracies in x-axis orientation of the carriage 1222 as the carriage 1222 is moved along the beam 1216. While in the exemplary embodiment of FIG. 12, each of the bearings 1286, 1287, and 1288 include actuators, one or more bearings can optionally be fixed or passively movable (such as with a spring-loaded mount). For example, in one exemplary embodiment, the bearing 1286 can be passively movable, and thereby passively compensate for actuation of adjustable bearings 1287 and 1288. As a further example, bearing 1288 can be fixed relative to the carriage 1222, and as the adjustable bearing 1287 is actuated, bearing 1286 can be passively or actively adjustable to compensate for the movement of bearing 1287. Likewise, bearing 1287 could be fixed, while one or both of bearings 1286 and 1288 could include an actuator.

Referring now to FIG. 13, an approach for achieving a rotation about the y-axis is shown. The view of FIG. 13 is rotated 90 degrees about the z-axis from the view of FIG. 12, and is a cross-section taken in a plane in which a longitudinal axis of the beam lies. The y-axis extends into and out of the plane of the drawing in FIG. 13. In the view of FIG. 13, two adjusting bearings 1390 and 1392 are positioned at the top of the carriage 1222. To rotate the carriage 1222 and printhead 1224 about the y-axis in a counter-clockwise rotation, the adjusting bearing 1390 is extended relative to the carriage 1222, while the adjusting bearing 1392 is retracted relative to the carriage 1222, causing the carriage 1222 to rotate relative to the beam 1216 as indicated by arrows R in FIG. 13. A clockwise rotation about the y-axis can be achieved by extending the adjusting bearing 1392 and retracting the adjusting bearing 1390 relative to the carriage 1222, thereby reversing the direction of rotation R. While in the exemplary embodiment of FIG. 13 both the adjusting bearings 1390 and 1392 are shown and described as being connected to actuators, in other exemplary embodiments only one of adjusting bearings 1390 and 1390 includes an actuator and a stationary bearing is used in place of the other of adjusting bearings 1390 and 1392. Rotations in either direction about the y-axis are possible by extending or retracting the one adjusting bearing, while the stationary bearing remains a fixed distance from the carriage 1222. In this manner, inaccuracies in y-axis orientation arising as the carriage 1222 is moved along the beam 1216 can be compensated for.

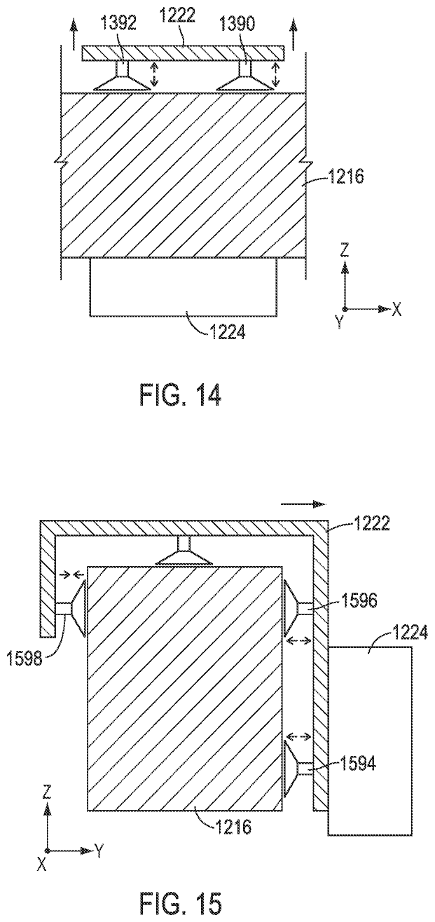

Referring now to FIG. 14, a view similar to FIG. 13 is shown, with a cross-section of the beam 1216 and carriage 1222 taken in a plane in which a longitudinal axis of the beam 1216 lies. To adjust the position of the carriage 1222 and printhead 1224 in the z-direction relative to the beam 1216, the adjusting bearings 1390 and 1392 are simultaneously extended or retracted to raise or lower (in the orientation of FIG. 14) the carriage 1222 relative to the beam 1216 as necessary to correct for inaccuracies in z-position that arise as the carriage 1222 moves along the beam 1216. While two adjusting bearings 1390, 1392 are shown in FIG. 14, embodiments having a single adjusting bearing centrally located on the carriage 122, or more than two adjusting bearings, are within the scope of the disclosure.

Referring now to FIG. 15, a view similar to FIG. 12 is shown, with a cross-section of the beam 1216 taken in a plane normal to the longitudinal axis of the beam 1216. To adjust the position of the carriage 1222 in the y-direction, adjusting bearings 1594 and 1596 are extended, while adjusting bearing 1598 is retracted, and the carriage 1222 moves in the y-direction. To reverse the movement of the carriage 1222 in the y-direction, the adjusting bearings 1594 and 1596 are retracted, while the adjusting bearing 1598 is extended. In this manner, inaccuracies in position of the carriage 1222 and printhead 1224 in the y-direction can be compensated for.

Various exemplary embodiments of the disclosure provide orientation changes of the carriage 1222 and printhead 1224 about any one or combination of the x-, y-, and z-axes, and translational movements of the carriage 1222 and printhead 1224 along any or both directions normal to a direction of motion of the carriage 1222 along the beam 1216 (i.e., the y- and z-axes depicted in the figures). Adjustments can be made in a dynamic manner based on real-time feedback, such as is described in connection with the workflow of FIG. 8. Alternatively, adjustments can be made based on data collected and recorded during a calibration process, such as described in connection with the workflows of FIGS. 9 and 10.

Devices manufactured using embodiments of the devices, systems, and methods of the present disclosure may include, for example and without limitation, electronic displays or display components, printed circuit boards, or other electronic components. Such components may be used in, for example, handheld electronic devices, televisions or computer displays, or other electronic devices incorporating display technologies.

It is to be understood that the particular examples and embodiments set forth herein are non-limiting, and modifications to structure, dimensions, materials, and methodologies may be made without departing from the scope of the present teachings. Other embodiments in accordance with the present disclosure will be apparent to those skilled in the art from consideration of the specification and practice of the invention disclosed herein. It is intended that the specification and examples be considered as exemplary only, with the following claims being entitled to their fullest breadth, including equivalents, under the applicable law.

What is claimed is:

1. A method of controlling a printing system having a printhead carriage supporting a printhead and mounted to translate along a beam extending in an x-axis direction of an x-axis, y-axis, z-axis Cartesian coordinate system, the method comprising:
sensing one or more of a rotational orientation of the printhead about the x-axis, the y-axis, or the z-axis and a position of the printhead along the y-axis or z-axis; and
based on the sensed one or more of the rotational orientation and the position, adjusting a position of one or more bearings arranged to support the printhead carriage on the beam, wherein adjusting the position of the one or more bearings adjusts one or more of the rotational orientation of the printhead and the position of the printhead.

2. The method of claim 1, wherein adjusting a position of the one or more bearings comprises actuating an actuator.

3. The method of claim 1, wherein adjusting the position of the one or more bearings comprises adjusting the position of the one or more bearings until the printhead carriage reaches one or both of a target rotational orientation and a target position.

4. The method of claim 3, further comprising sensing information related to one or both of the rotational orientation of the printhead and the position of the printhead to confirm the printhead is in one or both of the target rotational orientation and the target position.

5. The method of claim 3, further comprising sensing information related to a position of the one or more bearings when the printhead carriage reaches the one or both of the target rotational orientation and the target position.

6. The method of claim 1, further comprising sensing a position of the printhead carriage along the beam extending in the x-axis direction.

7. The method of claim 1, wherein the adjusting the position of the one or more bearings occurs during printing on a print surface lying in an x-y plane while the printhead moves along the beam extending in the x-axis direction.

8. A method of controlling a printing system having a printhead carriage supporting a printhead and mounted to translate along a beam extending in an x-axis direction of an x-axis, y-axis, z-axis Cartesian coordinate system, the method comprising:
sensing information related to a position of the printhead along a path of travel extending in the x-axis direction;
sensing information related to one or more of a rotational orientation of the printhead about the x-, y-, and z-axes and a position of the printhead along the y- and z-axes;
adjusting one or both of the rotational orientation and position of the printhead by adjusting a position of one or more bearings of a printhead carriage carrying the printhead; and
storing information correlating positions of the one or more bearings of the printhead carriage with corresponding positions of the printhead carriage along the path of travel.

9. The method of claim 8, wherein storing information correlating positions of the one or more bearings of the printhead carriage comprises receiving information relating to the positions of the one or more bearings of the printhead carriage from an encoder.

10. The method of claim 8, wherein sensing information related to one or more of the rotational orientation of the printhead and the position of the printhead comprises sensing information with a laser interferometer.

11. The method of claim 8, wherein sensing information related to one or more of the rotational orientation and the position of the printhead comprises imaging calibration marks of a calibration device with a camera.

12. A printing system, comprising:
a substrate support system configured to support a substrate having a surface to be printed, wherein the substrate support system is configured to maintain the surface to be printed in an x-y plane substantially normal to a z-axis of an x-axis, y-axis, z-axis Cartesian coordinate system;
a beam extending across the substrate support system in an x-axis direction; and
a printhead carriage movably coupled to the beam to move in the x-axis direction, the printhead carriage comprising one or more bearings positioned to support the printhead carriage relative to the beam,
wherein at least one of the one or more bearings is coupled to an actuator selectively adjustable to adjust one or more of a rotational orientation of the printhead carriage about the x-axis, y-axis, and z-axis and a position of the printhead carriage in a y-axis direction and a z-axis direction.

13. The printing system of claim 12, wherein the at least one of the one or more bearings comprises a gas bearing with a bearing surface facing the beam.

14. The printing system of claim 13, wherein the at least one of the one or more bearings is adjustable along a longitudinal axis of the bearing, the longitudinal axis being normal to the bearing surface.

15. The printing system of claim 13, further comprising at least one ball-and-socket joint coupling a bearing of the one or more bearings to the printhead carriage.

16. The printing system of claim 15, further comprising an actuation mechanism coupling a bearing of the one or more bearings to the printhead carriage.

17. The printing system of claim 16, wherein the actuation mechanism comprises a piezoelectric element.

18. The printing system of claim 16, further comprising an elastically-biased member coupled between the one or more bearings and the printhead carriage.

19. The printing system of claim 18, wherein the elastically-biased member is coupled between the one or more bearings and the printhead carriage in parallel with the actuation mechanism.

20. The printing system of claim 18, wherein the elastically-biased member comprises a coil spring.

21. The printing system of claim 18, wherein the elastically-biased member comprises a pneumatic piston-cylinder device.
